(19) United States
(12) Patent Application Publication
(10) Pub. No.: US 2012/0006082 A1
(43) Pub. Date: Jan. 12, 2012

(54) ELECTRIC LOCK

(76) Inventor: FU-CHANG PENG, Taipei (TW)

(21) Appl. No.: 12/832,073

(22) Filed: Jul. 8, 2010

(51) Int. Cl. E05B 47/02

(52) U.S. Cl. 70/277

(57) ABSTRACT

An electric lock includes an outer door housing, nexus, inner door housing, and a latch bolt. The outer lock housing is arranged to an outer side of a door. The nexus is connected to the outer door housing. The inner door housing is connected to the nexus and arranged to an inner side of the door. The latch bolt is connected to a latch bolt retaining unit of the nexus. An actuator of the nexus will extend a guiding block and a protruded block to engage the outer handle to the nexus for opening the door while user inputting a correct password to the electric lock. The door can be opened by a proper key also. The nexus will be isolated from the outer handle to prevent damage to the nexus while a user does not have a right key and password to the electric lock.

### FIELD OF THE PRESENT INVENTION

The present invention relates to door lock, and particular to an electric lock.

### DESCRIPTION OF THE PRIOR ART

Home and property safety are seriously concerned by people nowadays as well as door entrance security. Therefore, multiple door locks are usually applied to single door to increase the safety.

To improve residential security, electric locks for door are provided to market. A password preset to such electric lock with a proper key to the door is needed to open the door so as to ensure the safety. However, if one of the password or the key for the door is not available, the user might need to break the lock by forcing to rotate the door handle for the purpose of opening the door. Apparently the broken electric lock is no longer functional, and additional cost is needed for repairing or replacement. Thieves might also break into the door through this way. Such design still has defective to solve.

### SUMMARY OF THE PRESENT INVENTION

Accordingly, the primary object of the present invention is to provide an electric lock applying to a door lock so that user can open the door without a door key.

Through the present invention, an actuator of a nexus of the electric lock will extend a guiding block and a protruded block to engage the outer handle of the door to the nexus for opening door while user inputting a correct password to the electric lock. The door can be opened by key also. The nexus will be isolated from the outer handle to prevent damage to the nexus while a user does not have a right key and password to the electric lock.

### BRIEF DESCRIPTION OF THE DRAWINGS

FIG. 1 is an exploded view showing an electric lock of the present invention.

FIG. 2 is an exploded view showing a nexus of the present invention.

FIG. 3 is an exploded view showing the nexus of the present invention from a different angle.

FIG. 4 is an exploded view showing an actuator of the present invention.

FIG. 5 is a cross section view showing the actuator of the present invention.

FIG. 6 is a schematic view showing a normal status of the actuator of the present invention.

FIG. 7 is a schematic view showing the operation of the actuator of the present invention.

FIG. 8 is an assembling view showing the actuator and a second transmitting unit of the present invention.

FIG. 9 is a schematic view showing an engagement of the actuator and the second transmitting unit of the present invention.

FIG. 10 is a schematic view showing an operation of the actuator and the second transmitting unit illustrated in FIG. 9.

FIG. 11 is a schematic view a further engagement of the actuator and the second transmitting unit of the present invention.

FIG. 12 is a schematic view showing an operation of the actuator and the second transmitting unit illustrated in FIG. 11.

FIG. 13 is a schematic view showing a normal status of a latch bolt of the present invention.

FIG. 14 is a schematic view showing an operation of the latch bolt of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

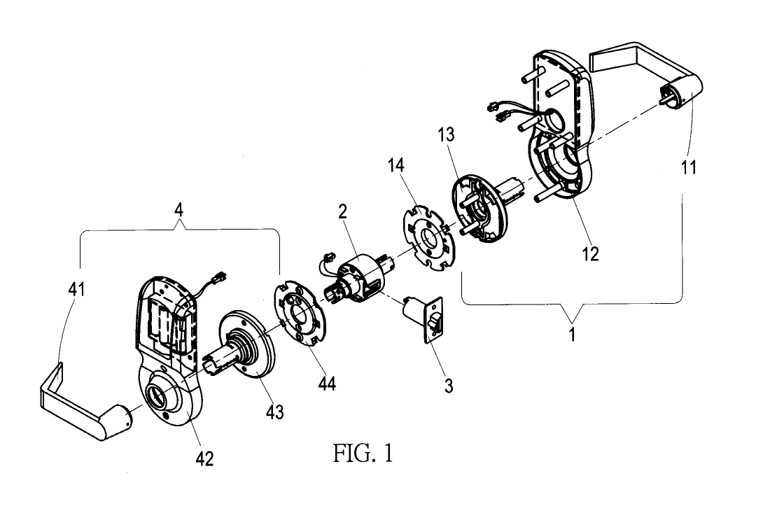

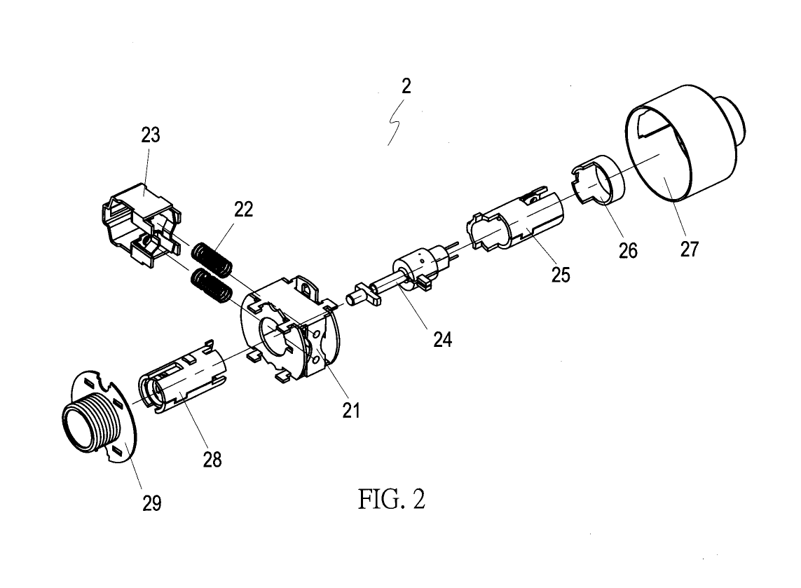

Referring to FIG. 1, an exploded view of the present invention is illustrated. An outer lock housing 1 is arranged to an outer side of a door. The outer lock housing 1 includes an outer handle 11, outer panel 12, outer transmitting unit 13, and an outer retaining plate 14. The outer transmitting unit 13 is slid and arranged to the outer panel 12 from an inner side of the outer panel 12, and the outer handle 11 is connected to the outer transmitting unit 13 from an outer side of the outer panel 12. Then the assembly is fixed to the outer retaining plate 14. A nexus 2 is connected to the outer lock housing 1, and an inner lock housing 4 is also connected to the nexus 2. The inner lock housing 4 is arranged to an inner side of the door. The inner lock housing 4 includes an inner handle 41, inner panel 42, inner transmitting unit 43 and an inner retaining plate 44. The inner transmitting unit 43 is slid and arranged to the inner panel 42 from an inner side of the inner panel 42, and the inner handle 41 is arranged to the inner transmitting unit 43 from an outer side of the inner panel 42. Then the assembly is fixed to the inner retaining plate 44. A latch bolt 3 is linked to a latch bolt retaining unit 23 of the nexus 2 as shown in FIG. 2. The outer transmitting unit 13 and an opposite inner transmitting unit 43 both have spring serving to restore the rotated handles. The outer handle has a key hole, lock core, and a column linked together. The column passing through the outer transmitting unit 13 is connected to the nexus 2. The lock core will drive the column while a user using a key so that the nexus 2 will also be driven to open the door.

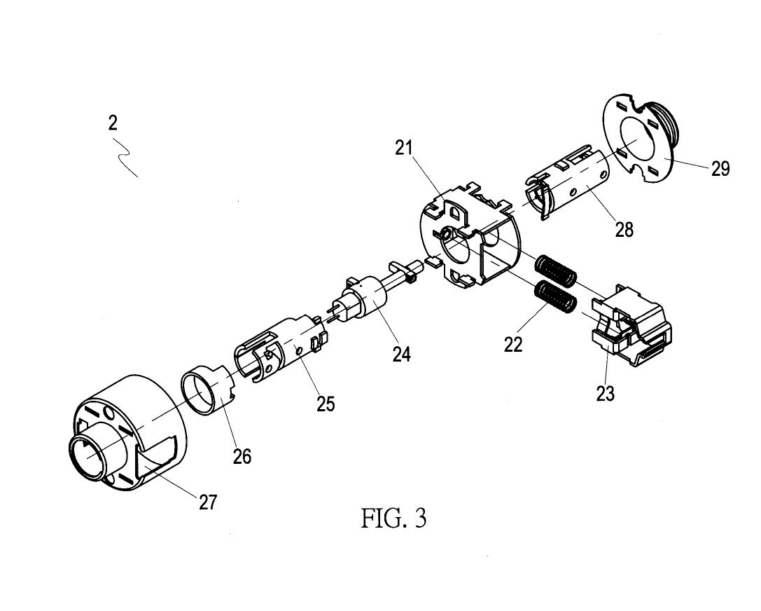

Referring to FIGS. 2 and 3, the nexus 2 includes a base 21, spring unit 22, latch bolt retaining unit 23, actuator 24, first transmitting unit 25, sleeve 26, cover 27, second transmitting unit 28, and a base retaining unit 29. The latch bolt retaining unit 23 linked to the spring unit 22 is arranged to the nexus base 21. The actuator 24 is arranged through the first transmitting unit 25 and the base 21. The sleeve 26 and the nexus cover 27 are slid upon the first transmitting unit 25 and the nexus cover 27 respectively. The second transmitting unit 28 is slid to the base 21 from an opposite side, and the base retaining unit 29 is arranged upon the second transmitting unit 28 and the base 21.

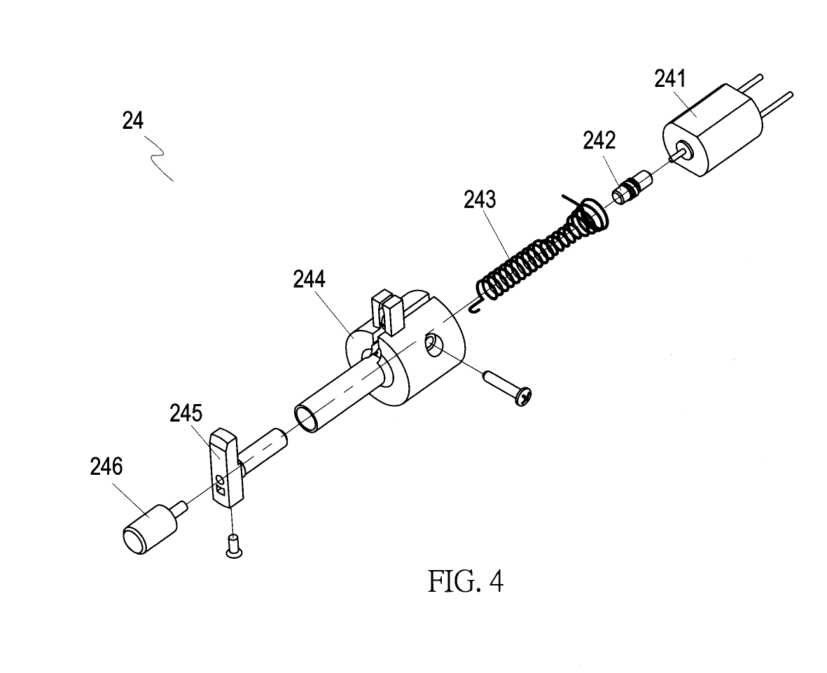

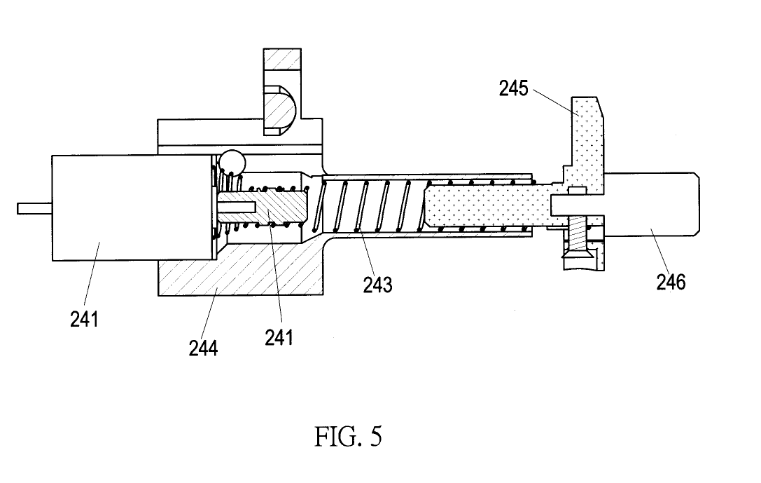

Referring to FIGS. 4 and 5, the actuator 24 includes a motor 241, rotor 242, elastic component 243, actuator case 244, guiding block 245, and a protruded block 246. The rotor 242 is arranged to the motor 241, and the elastic component 243 is connected to the rotor 242. The actuator case 244 is covered upon the motor 241, and the actuator case 244 is tightened to the motor 241 by a fastening component. The protruded block 246 is arranged to the guiding block 245, and the elastic component 243 passing through the actuator case 244 is fixed to the guiding block 245 by a fastening component.

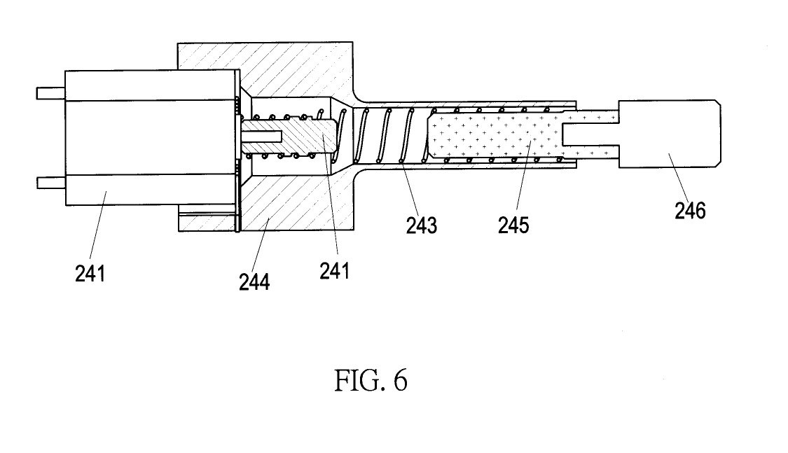

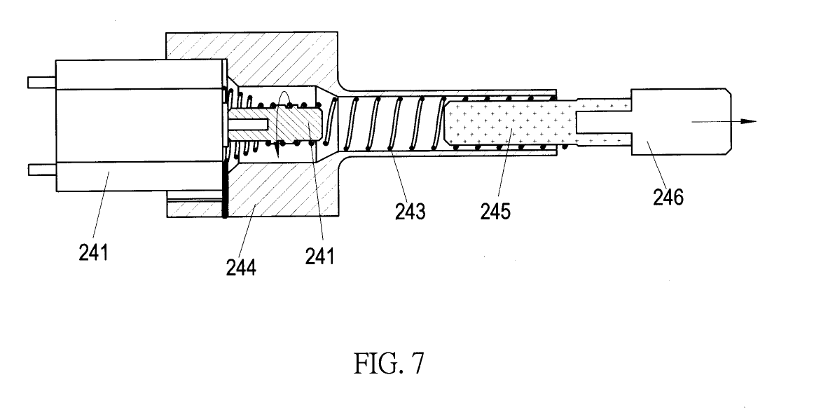

Referring to FIGS. 6 and 7, the operation of the present invention is illustrated. The end of the elastic component 243 connected to the rotor 242 is tense. While the motor 241 is rotating, the rotating rotor 242 will drive the elastic component 243 to extend forward so as to move the guiding block 245 and the protruded block 246 forward.

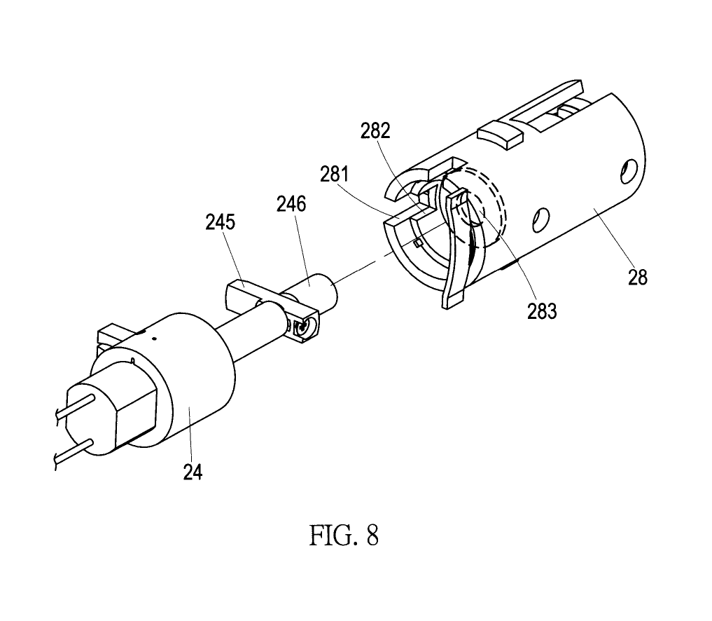

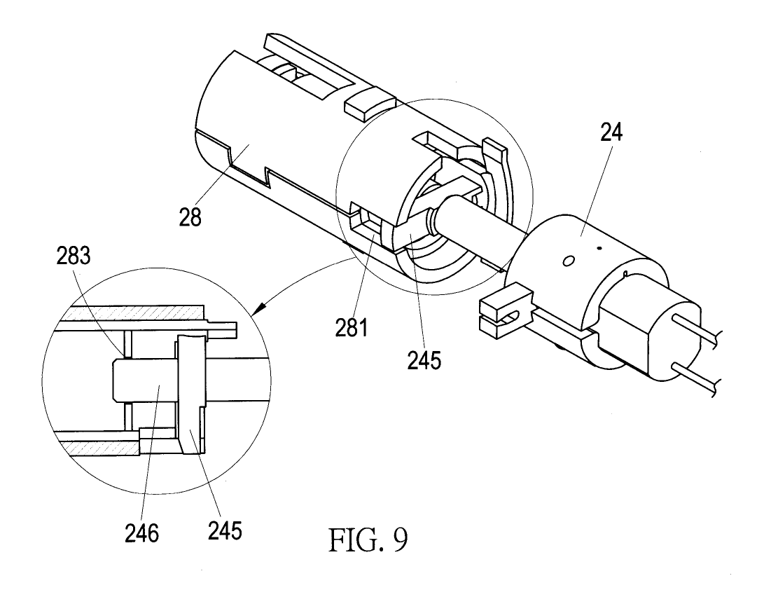

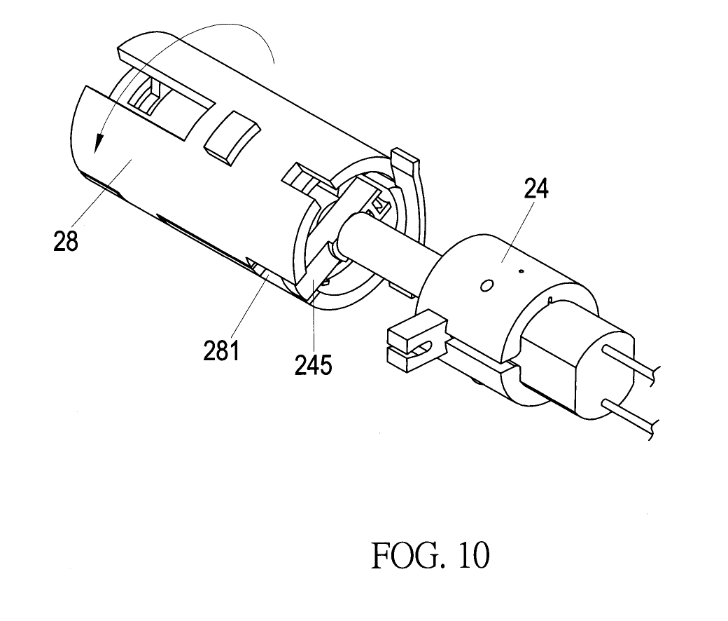

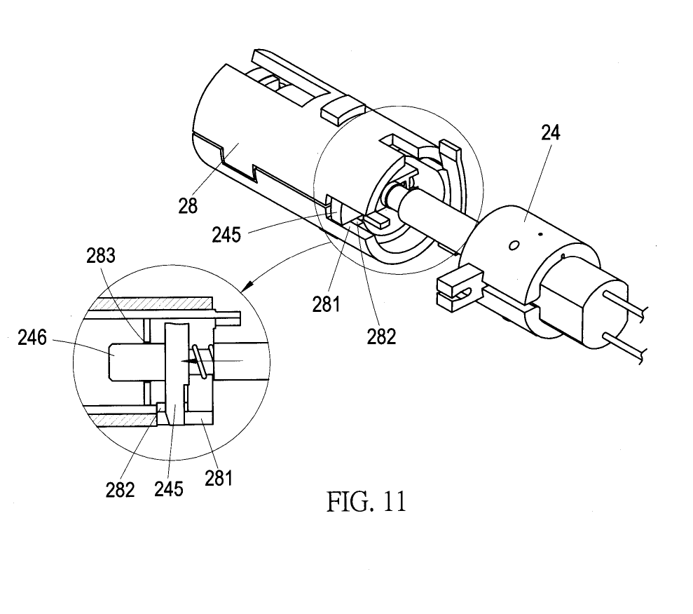

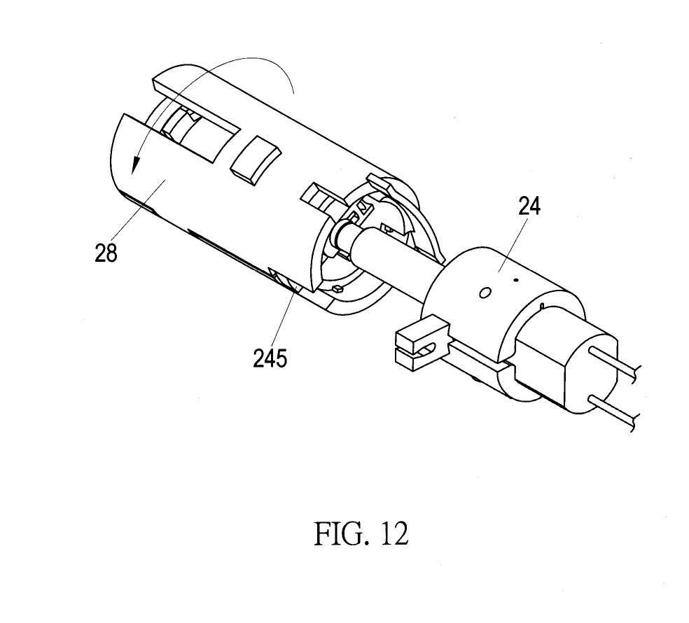

Referring to FIGS. 8 to 12, the second transmitting unit 28 has a first guiding cut 281, a second guiding cut 282, and a guiding hole 283. While the actuator 24 is not activated, the protruded block 246 is received to the guiding hole 283, and the guiding block 245 is engaged to the first guiding cut 281. The second guiding cut 282 is not engaged to the guiding block 245 so that the second transmitting unit 28 can not drive the nexus 2 to open the door. While the actuator 24 is activated, the protruded block 246 will be move even forward to engage to the second guiding cut so that the second transmitting unit 28 linked to the outer handle can drive the nexus 2 to open the door.

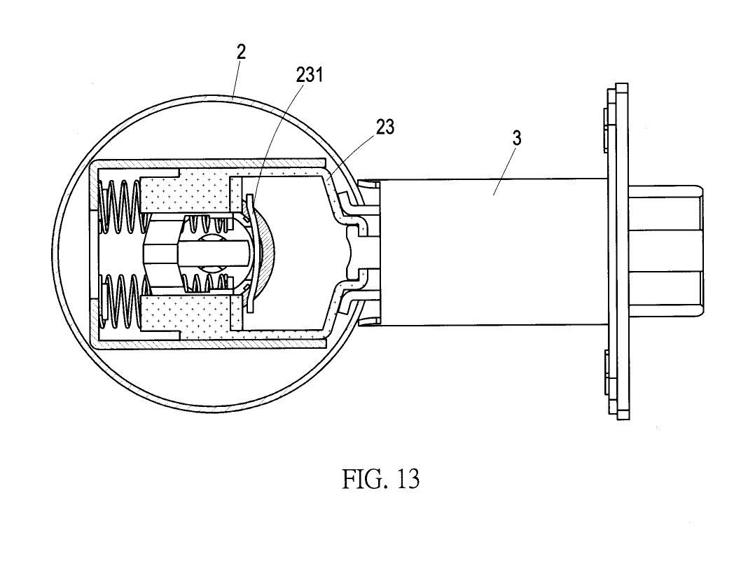

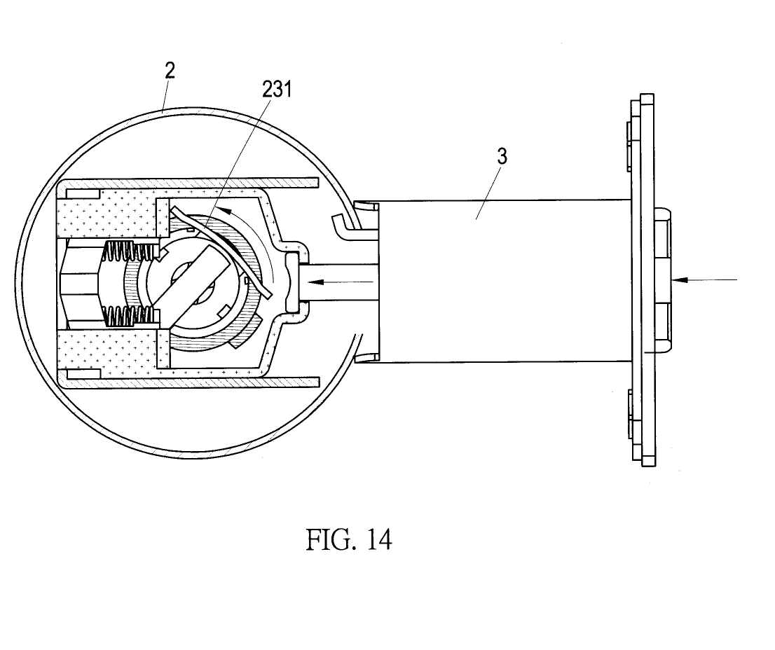

Referring to FIGS. 13 and 14, the latch bolt retaining unit 23 is connected to the latch bolt 3. While the nexus 2 is rotated, a driving plate 231 is rotated to retreat the latch bolt 3.

The present invention has the following advantages.

1. Users can open the door without a key.

2. The door can be opened by the door key instead of using password to unlock.

3. The nexus and the outer handle are isolated so as to prevent the transmitting unit from damage while a user does not have a key or password.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electric lock comprising:
an outer lock housing arranged to an outer side of a door plate having an outer handle, outer panel, outer transmitting unit, and an outer retaining plate; the outer transmitting unit being slid and arranged to the outer panel; the outer handle being connected to the outer transmitting unit from an outer side of the outer panel; the outer retaining plate is fixed to the outer transmitting unit from an inner side thereof;
an nexus connecting to the outer lock housing having a base, elastic component, latch bolt retaining unit, actuator, first transmitting unit, sleeve, cover, second transmitting unit, and a base retaining unit; the latch bolt retaining unit linked to the elastic component being arranged to the nexus base; the actuator being arranged through the first transmitting unit and the base; the sleeve and the cover being slid upon the first transmitting unit and the base respectively; the second transmitting unit being slid to the base from an opposite side, and the base retaining unit being arranged upon the second transmitting unit and the base;
an inner lock housing arranged to the nexus from an inner side of the door having an inner handle, inner panel, inner transmitting unit and an inner retaining plate; the inner transmitting unit being slid and arranged to the inner panel; the inner handle being connected to the inner transmitting unit from an outer side of the inner panel; the inner retaining plate being fixed to the inner transmitting unit from an inner side thereof;
a latch bolt linked to the latch bolt retaining unit.

2. The electric lock as claimed in claim 1, wherein the actuator includes a motor, rotor, elastic component, case, guiding block, and a protruded block.

3. The electric lock as claimed in claim 2, wherein the case is tightened to the motor by a fastening component.

4. The electric lock as claimed in claim 2, wherein the protruded block, guiding block, and the elastic component are connected by a fastening component.

5. The electric lock as claimed in claim 1, wherein the outer handle has a key hole, lock core, and a column.

6. The electric lock as claimed in claim 1, wherein the outer panel has a set of push button.

7. The electric lock 1 as claimed in claim 1, wherein the inner panel has a battery set electrically connected to the actuator.

8. The electric lock as claimed in claim 1, wherein the outer panel has a circuit board electrically connected to the actuator.
